(19) United States
(12) Patent Application Publication
(10) Pub. No.: US 2015/0043983 A1
(43) Pub. Date: Feb. 12, 2015

(54) SPADE DRILL

(71) Applicant: Performance Carbide, Inc., Waterloo, IA (US)

(72) Inventors: Gerald A. Gass, Waterloo, IA (US); Kenneth L. Kammeyer, Waterloo, IA (US); Dennis L. Schmidt, Waterloo, IA (US)

(21) Appl. No.: 14/337,726

(22) Filed: Jul. 22, 2014

Related U.S. Application Data
(60) Provisional application No. 61/862,606, filed on Aug. 6, 2013.

(51) Int. Cl. B23B 51/00; B23B 51/06

(52) U.S. Cl. CPC B23B 51/0009; B23B 51/06; B23B 2251/48; B23B 2251/18; B23B 2250/12; B23B 2251/02; B23B 2251/082
USPC 408/231; 408/199; 408/227

(57) ABSTRACT

A drill, such as a spade drill, is provided. The drill includes a drill body that includes a mounting end and a cutting end. The cutting end includes first and second cutting edges that are generally curved along the entirety of the cutting end of the drill body, removing any sort of cutting corner. The curved cutting edge provides a more resilient drill for removing material from a workpiece. The cutting edges may also include a drilling point at a distal end and at least partially between the first and second edges, along with webs extending from the drilling point to the cutting edges. The mounting portion includes structure to attach the drill to a holder, which can connect to a rotating apparatus for rotating the holder and drill.

### CROSS-REFERENCE TO RELATED APPLICATIONS

This application claims priority under 35 U.S.C. §119 to provisional U.S. application Ser. No. 61/862,606, filed Aug. 6, 2013, herein incorporated by reference in its entirety.

### FIELD OF THE INVENTION

The invention relates generally to a spade drill insert to be placed into a tool holder for boring holes into metals. More specifically, but not exclusively, the invention relates to a spade drill insert having cutting edges with a curved radius along the cutting edges to provide an improvement for drilling holes.

### BACKGROUND OF THE INVENTION

Drilling systems are frequently used to provide cylindrical holes in metallic work pieces. The cutting or boring action of the drill system may be carried out by an elongated, substantially cylindrical drilling tool, such as a combination of a tool holder and a spade drill insert, which is selectively attached thereto. Such an arrangement may then be used in an application wherein one end of the tool holder is securely mounted in a driving apparatus, which rotates the holder about its longitudinal axis. At the opposite end of the elongated tool holder, the cutting insert engages the material to be cut. Alternatively, the workpiece may be made to rotate relative to the holder and cutting insert, such as in positioning the holder in the tail stock of a lathe or the like. Further, the tool and workpiece may be made to rotate relative to one another. The use of spade drill cutting inserts allows for quick changing of the insert upon wear of the cutting surfaces instead of the entire tool, and allows for one tool to be used for a variety of different boring applications by simply changing the insert and not the entire drill assembly.

Spade drill inserts are characterized in that they are generally flat having a pair of connection surfaces or faces on opposite sides of the insert that are substantially parallel to each other and provide a register surface for the clamping arms of the holder. The leading end of the spade drill typically has a pair of straight, transverse cutting edges in the form of an obtuse V. The trailing end or base of the spade drill insert is typically planar and perpendicular to the pair of connection surfaces and engages the bottom of the holder slot. The sides across the width of the insert provide the margin and a clearance for the insert. The margin is cylindrically formed about the rotational axis of the spade drill and contacts the side of the hole during drilling operations.

One issue with regards to standard spade drill inserts is their limitation in bore size.

The geometry of the spade drills worked with smaller sized holes, but larger drills would be too expensive and would not work well due to the forces being applied along the cutting edges of the drills. As the drills became wider, they would also have to become thicker to provide structural integrity to account for the forces being applied at the cutting edges a distance from the longitudinal axis of the drill. Thus, the amount of material needed would greatly increase the cost of the spade drill.

### SUMMARY OF THE INVENTION

Therefore, it is a primary object, feature, and/or advantage of the invention to overcome and/or improve on the deficiencies in the art.

It is another object, feature, and/or advantage of the invention to provide a spade drill having cutting edges with curved radii.

It is yet another object, feature, and/or advantage of the invention to provide a spade drill for use with a holder that improves the tool life of the drill. It is still another object, feature, and/or advantage of the invention to provide a spade drill that reduces cycle time.

It is a further object, feature, and/or advantage of the invention to provide a spade drill that provides larger cutting surfaces by spreading out the cutting forces for the drill.

It is yet a further object, feature, and/or advantage of the invention to provide a spade drill that provides for quieter operation, reduces heat at the cutting edge, allows for higher feed rates, and mitigates burring on the exit hole.

These and/or other objects, features, and advantages of the invention will be apparent to those skilled in the art. The invention is not to be limited to or by these objects, features and advantages. No single embodiment need provide each and every object, feature, or advantage.

The invention is directed towards a spade drill having a curved or radiused form along the cutting edges. The radius extends along the entire cutting edge, from one side of the drill to the other. The cutting edge of the drill may include chip breaking slots, as well as secondary edges (curved or straight) where the cutting edge intersects the faces of the drill. Furthermore, the cutting edge may include an edge preparation, such as a hone, K-land, T-land, or some combination thereof. The spade drill according to the invention may comprise tungsten carbide, high speed steel, super cobalt, or other cutting tool materials.

The spade drill provides a significantly larger cutting surface, which spreads out the cutting forces, provides for quieter operation, reduces heat at the cutting edge, allows for higher feed rates, and can eliminate or mitigate burring on the exit hole. Additional benefits include improved tool life, reduced cycle time, and reduced noise levels.

### EXEMPLARY DRAWINGS

FIG. 1 is a front elevation view of a spade drill.

FIG. 2 is a side elevation view of the spade drill of FIG. 1.

FIG. 3 is a top elevation view of the spade drill of FIG. 1.

FIG. 4 is a front elevation view of a spade drill according to aspects of the invention.

FIG. 5 is a side elevation view of the spade drill of FIG. 4.

FIG. 6 is a top elevation view of the spade drill of FIG. 4.

FIG. 7 is a front elevation view of a spade drill tip according to aspects of the invention

FIG. 8 is a top elevation view of the drill tip of FIG. 7.

FIG. 9 is a side elevation view of the drill tip of FIG. 7.

FIG. 10 is a front elevation view of another drill tip according to aspects of the invention.

FIG. 11 is a top elevation view of the drill tip of FIG. 10.

FIG. 12 is a side elevation view of the drill tip of FIG. 10. Various embodiments of the invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE EXEMPLARY EMBODIMENTS

The invention is directed towards a spade drill 10 of the type used for removing material from a hard material workpiece, such as cast iron, steel, or the like. The spade drill of the invention can be used with an assembly including a drill holder (not shown). An example of a drill holder that may be used with the spade drill 10 of the invention is shown and described in U.S. Pat. No. 7,018,145, which is herein incorporated in its entirety. The holder is connected to a rotating or spinning apparatus, which rotates the holder and attached spade drill at a high speed. The workpiece and/or drill assembly is then moved into contact with one another such that the spade drill removes material from the workpiece to create a borehole therein or therethrough. The diameter of the borehole in the workpiece may be varied according to the width of the spade drill coming in contact with the workpiece.

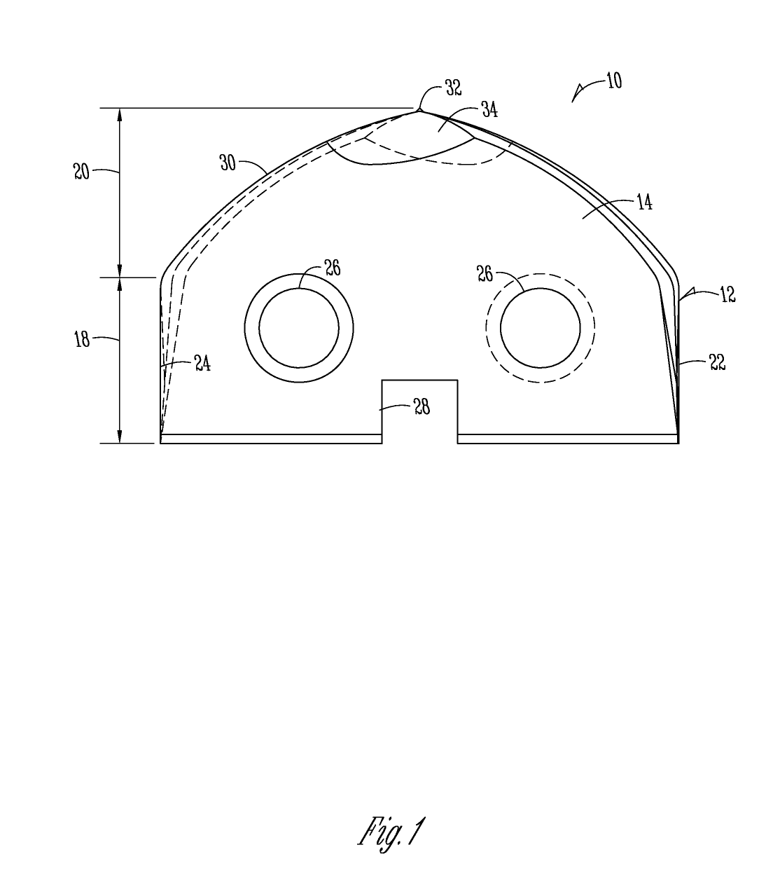

Accordingly, FIGS. 1-3 show aspects of a spade drill 10 for providing a borehole in a workpiece when the spade drill 10 is attached to a holder of a drill assembly. As will be understood, an advantage of the spade drill 10 shown in FIGS. 1-3 is that the drill includes cutting edges having a curved or radiused form along the cutting edges. The radiused cutting edge from one side to the other provides many advantages, such as spreading out the cutting forces of the spade drill, reducing the noise of operation, reducing the heat at the cutting edge, increasing the feed rate of the drill assembly, and also eliminating or mitigating burring on the exit hole of the workpiece. Additional advantages not included may be obtained through use of the spade drill 10 according to the invention.

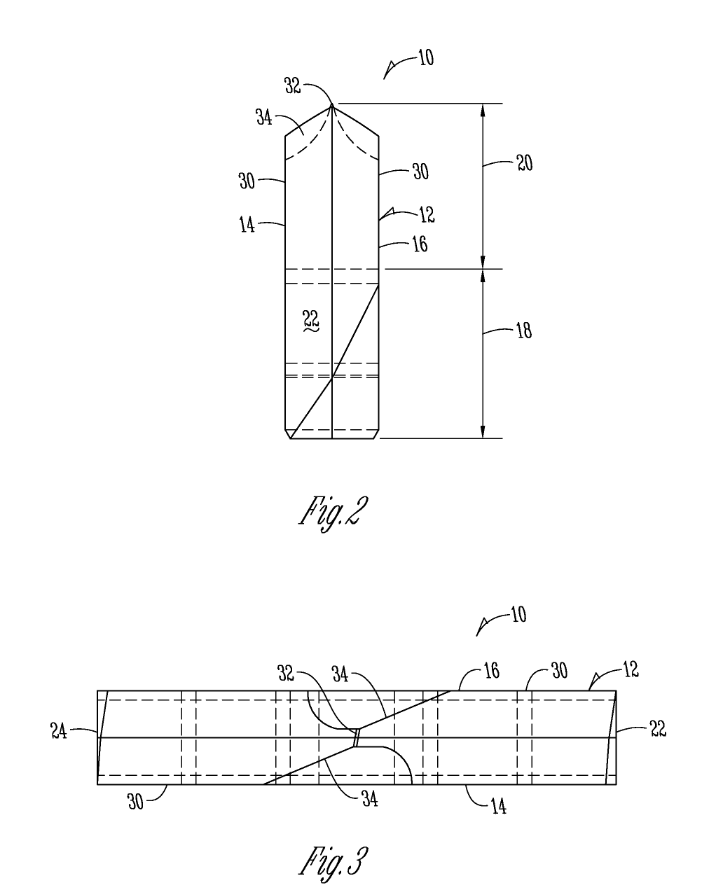

The spade drill 10 includes a body 12. The body 12 has a first face 14 and an opposite second face 16. The first and second faces 14, 16 may be substantially parallel to one another and may be substantially planar surfaces. First and second ends 18, 20 are included as part of the spade drill body 12. As shown in FIGS. 1 and 2, the first end 18 of the drill body 12 extends generally from the bottom edge of the spade drill 10 to a portion of the spade drill body wherein the cutting edge 30 begins. It should be noted that this configuration substantially eliminates any cutting corner for the spade drill 10. The second end 20 of the spade drill body 12 spans generally the height of the cutting edge extending to a drilling point or chisel 32 at an opposite edge of the lower end of the spade drill 10. Also shown in the figures are first and second sides 22, 24 of the spade drill body 12. The first and second sides 22, 24 extend the width of the spade drill body 12 and are positioned at opposite sides of the faces 14, 16. The first and second sides 22, 24 may be substantially parallel to one another, or may be tapered surfaces.

As shown best in FIG. 1, the first face 14 of the spade drill body 12 includes mounting apertures 26 and a mounting slot 28. The apertures and slot 26, 28 are used to attach the spade drill 10 to a holder, as is disclosed in U.S. Pat. No. 7,018,145. The exact configuration of the apertures and/or slot may be varied according to the holder connected or attached to the spade drill 10. It is also noted that the apertures and slot are generally within the first end 18 of the spade drill body 12. However, it should be appreciated that the invention contemplates that the apertures and/or slot extend at least partially into the second end 20 of the spade drill body 12, depending on the exact configuration of the spade drill 10 and/or holder attaching thereto.

A cutting edge 30 is shown in the Figures on both the first and second faces 14, 16 of the spade drill body 12. The cutting edge 30 is radiused and/or otherwise curved from the first side 22 to the second side 24 of the spade drill body 12, and is formed primarily or substantially entirely within the second end 20 of the spade drill body 12. Having the cutting edge 30 be radiused about the full second end 20 of the spade drill body 12 provides that there will be substantially no additional cutting corners or portions of the spade drill 10. Furthermore, the width of the spade drill body spanning along the full curved radius of the cutting edge 30 will provide the diameter of the borehole or cutting hole of the spade drill 10. It should be appreciated that the curved or radiused cutting edge 30 allows the thickness of the spade drill body 12, as generally noted as the thickness between the first and second faces 14, 16, to be less than would be needed when increasing the diameter of the borehole in the workpiece. The curved radius allows the forces acting on the spade drill 10 to be spread along the full curved or radiused cutting edge 30 such that a larger diameter borehole can be created without increasing the amount of material for the spade drill 10, i.e., increasing the thickness of the spade drill 10. In addition, it should be appreciated that the invention contemplates that there may or may not be an edge preparation of the cutting edges 30, which may be a hone, K-land, T-land, or some combination thereof. The edge preparations will provide additional benefits for cutting in certain materials or when needing different types of boreholes.

Additional components of the spade drill 10 include a chisel or point 32 at the distal end of the second end 20 of the spade drill body 12, as well as webs 34 on either side of the cutting edge 30 and generally at or near the chisel or point 32. The point 32 is used to initially penetrate the workpiece material during creation of the borehole therein and/or therethrough. The webs 34 are configured to aid in removing material therefrom and passing material outward away from the borehole and external from the borehole to aid in providing cooling for the material removal process. Therefore, the size and configuration of the chisel 32 and webs 34 may be varied according to specific need and/or type of material of the workpiece. For example, the webs 34 may include either positive or negative rake angles to provide for different material removing operations.

The spade drill 10 according to aspects of the invention may comprise generally any material capable of cutting work pieces. For example, the spade drill 10 may comprise tungsten carbide, high speed steel, super cobalt, or other cutting tool materials. The composition of the spade drill is not to be limited to the precise examples given, and may comprise generally any material capable of cutting other materials.

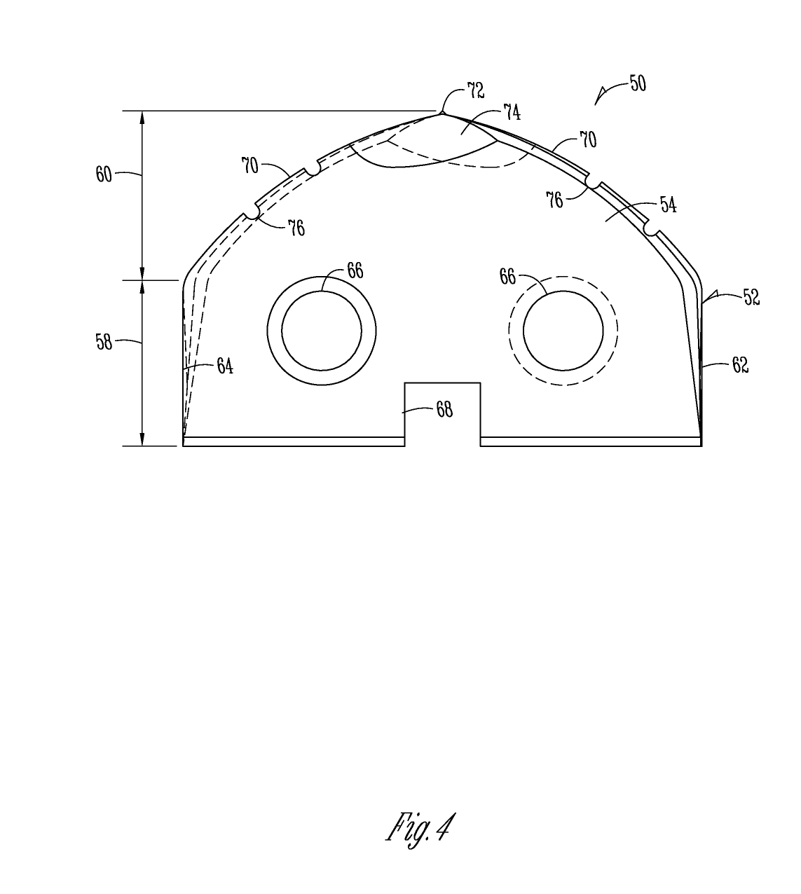

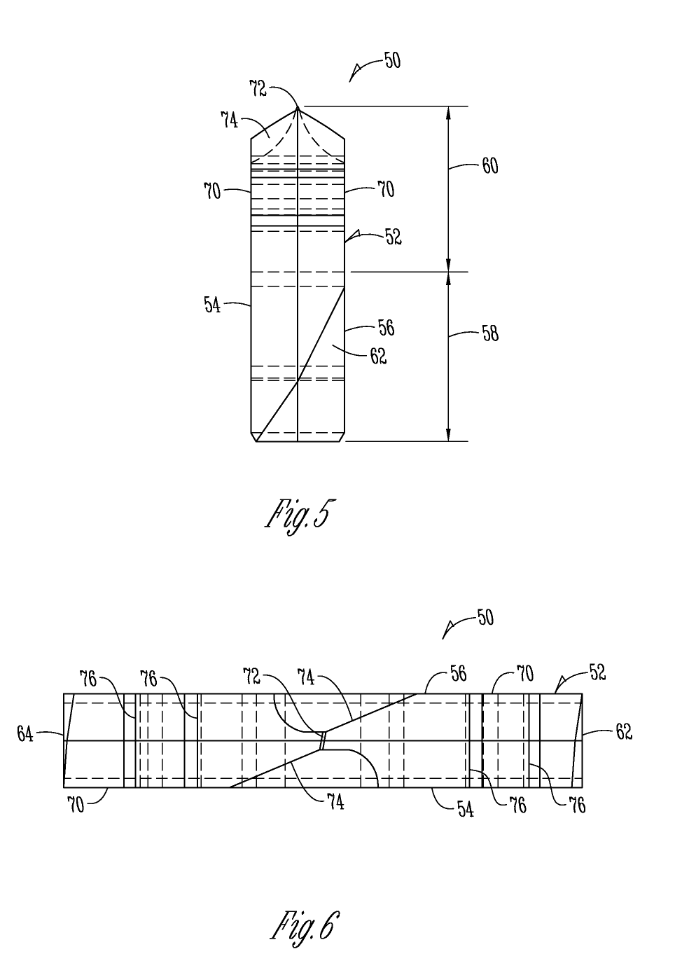

FIGS. 4-6 show additional aspects of a spade drill 50 according to the invention. As shown in FIGS. 4-6, the spade drill 50 is similar in configuration to the spade drill 10 shown and described above. For example, the spade drill 50 includes a body 52 including a first face 54 and an opposite second face 56. The first and second faces 54, 56 may be substantially parallel to one another and also may be substantially planar surfaces. The faces 54, 56 may also be tapered. The spade drill body 52 includes a first end 58 and a second end 60. As shown in FIGS. 4 and 5, the first end 58 extends generally from a lower most edge of the spade drill body 52 to a curved portion designating the start of a cutting edge 70. The second end 60 extends generally from the end of the first end 58 to the chisel or drilling point 72. Also found at the ends of the first and second faces 54, 56 are first and second sides 62, 64. The first and second sides define the width, whether constant or variable, of the spade drill 50 and may be substantially parallel to one another.

However, it is also been contemplated that the first and second end 62, 64 may be slightly tapered inwardly towards the longitudinal axis of the spade drill 50. In addition, the length from the first edge 62 to the second edge 64 generally defines the diameter of the borehole to be created in a workpiece by the spade drill 50.

Similar to the spade drill 10 shown in FIGS. 1-3, the spade drill 50 may be used with a drill assembly including a holder, such as a holder shown and described in U.S. Pat. No. 7,018,145. Therefore, the spade drill 50 may include apertures 66 and a slot 68. The apertures and slot 66, 68 are used to attach the spade drill 50 to a holder of a drill assembly such that the holder and spade drill can be rotated by a rotating mechanism and into contact with a workpiece to remove material therefrom to create a borehole.

The spade drill 50 includes a cutting edge 70 spanning from the first side 62 to the second side 64, with the cutting edge being radiused and/or curved about substantially the full length from the first side 62 to the second side 64. The cutting edge 70 is formed on generally both faces 54, 56 of the spade drill body 52 and is used to remove material from a workpiece. In addition, the cutting edge may include an edge preparation such as a hone, K-land, T-land, or some combination thereof. Similarly to the spade drill 10 described above, the curved cutting edge 70 of the spade drill 50 allows a larger diameter borehole to be made in a workpiece without increasing the amount of material required to created or otherwise form the spade drill 50. The curved radius of the cutting edge 70 spreads out the cutting forces along the full cutting edge, which provides a stronger spade drill without increasing the width thereof. This aids in keeping the cost of forming the spade drill 50 at a minimum. Additional benefits and/or advantages of having the curved cutting edge include a significantly larger cutting surface, a quieter cutting operation, a reduction in heat at the cutting edge, a higher feed rate for creating a borehole, and an elimination or mitigation of burring on the exit hole through the workpiece. It is to be appreciated that this not an exhaustive list of benefits or advantages, and other benefits, advantages, and the like may be appreciated by those skilled in the art.

Additionally formed at the cutting edges 70 and spanning the thickness of the spade drill body 52 from a first face 54 to a second face 56 are a plurality of chip breaking slots 76 in the cutting edge 70. It should be appreciated that the slots 76 not need extend the full width of the spade drill, and can extend only partially through the drill. The chip breaking slots 76 aid in breaking up the material removed from the workpiece to aid in removing said material out the borehole during drilling the borehole through the workpiece. The slots 76 also provide additional cooling aspects to the spade drill 50 as the spade drill 50 bores a hole in the workpiece. Therefore, the number and configuration of the slots 76 may vary according to spade drill and may be varied according to such factors as type of material being drilled into, type of material comprising the spade drill, and the like.

Furthermore, while the slots 76 are shown to be generally perpendicular to the faces 54, 56 of the spade drill body 52, it should be appreciated that the slots may form an angle to the faces to provide additional benefits as well.

Additionally shown in the figures are a chisel 72 and web 74. The chisel is formed generally at the peak or distal end of the second end 60 of the spade drill 52, and is used to create an initial indent or hole in the workpiece. The webs are formed adjacent the chisel 72 on opposite faces thereof at the cutting edge 70. The webs 74 may include cutting surfaces with positive or negative rake angles, and also can be used to aid in removing the material from the spade drill out the borehole, while also providing cooling aspects to the edge of the spade drill. The exact configuration of the chisel and/or webs is not to be limiting to the invention, the invention contemplates generally any configuration thereof.

Additionally similar to the spade drill 10 above, the spade drill 50 may comprise generally any material capable of cutting workpiece materials. For example, the spade drill 50 may comprise of tungsten carbide, high-speed steel, super cobalt, or any other material capable of withstanding the forces required to remove material from work pieces comprising different compositions.

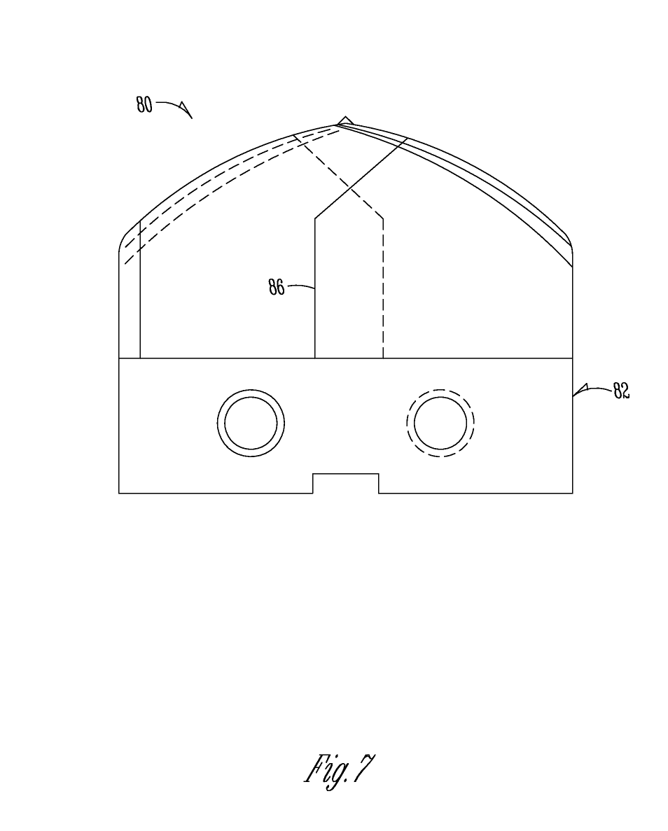

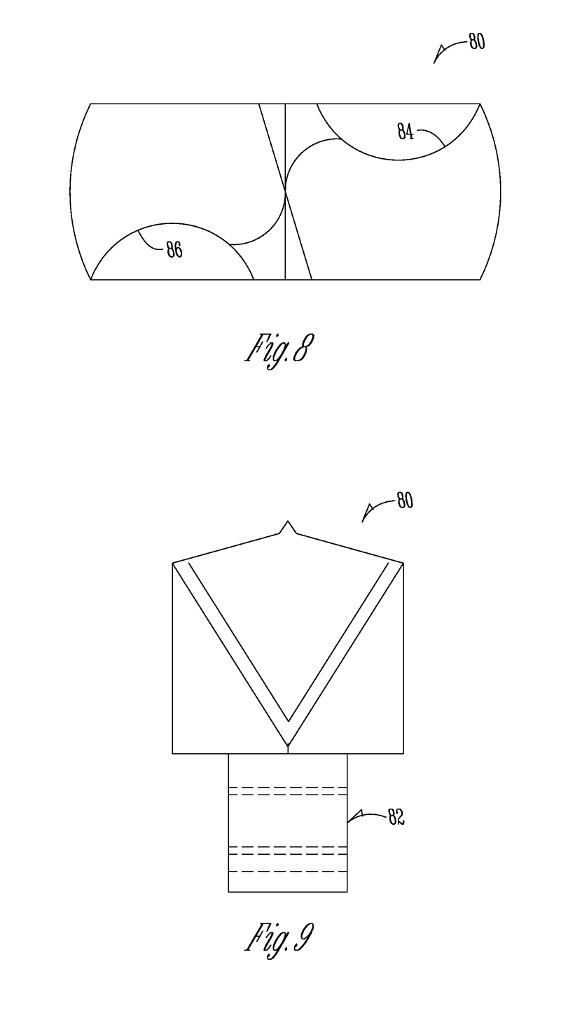

FIGS. 7-9 show additional aspects of a spade drill tip 80. The spade drill tip 80 includes many of the same features of the spade drill 10 shown and described. This includes the curved or radiused cutting edge spanning from one side of the tip to the other. However, the drill shown in FIGS. 7-9 is a replaceable drill tip. Thus, the mounting structure 82 differs from the other embodiments. The mounting structure 82 is configured to be attached to drill or other holders that allow the use of replacement or variable drill tips. One such holder is the BT-A drill, which is manufactured and sold by Allied Machine & Engineering Corp. In addition, other manufacturers have different drill holders to use the replacement tip.

It should be appreciated, therefore, that the drill tip 80 of the invention can be used with generally any type of drill that allows the drill tips to be attached thereto. Thus, while the mounting structure 82 shown in the figures includes a notch and two apertures, along with a thinner profile, the invention contemplates that this may vary according to the various manufacturers and industry standards. In either case, the curved profile of the cutting edge will still provide the same benefits that have been heretofore described regarding the drills 10, 50. In addition, the drill tip 80 also includes grooves 84, 86 formed in the faces of the tip 80. The grooves 84, 86 provide for a space to allow material to pass through the tip, while also providing cooling to the tip. The grooves 84, 86 are shown to be straight grooves in the figures, but it is to be appreciated that they could also be spiral grooves.

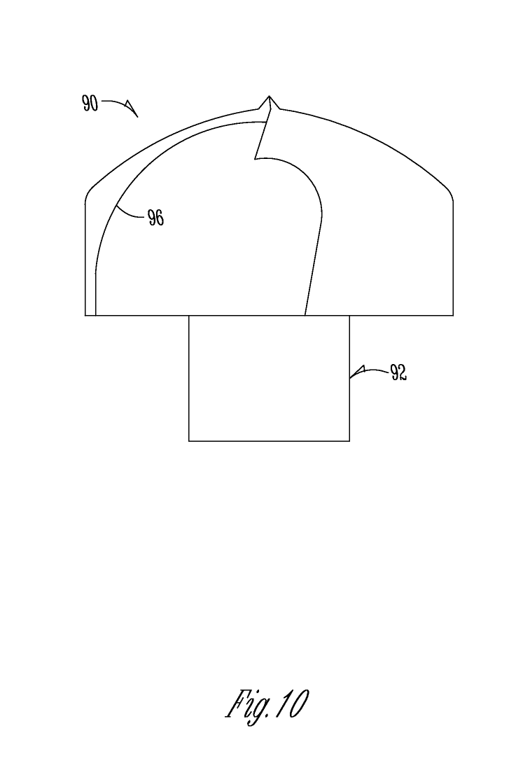

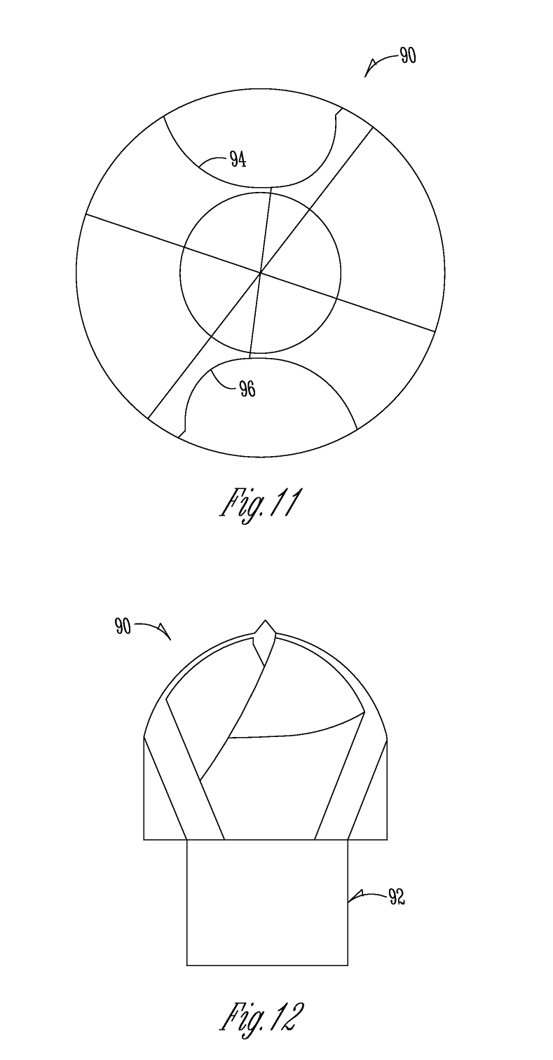

FIGS. 10-12 show yet additional aspects of the invention. A drill tip 90 is shown. The drill tip 90 can be used with replaceable drill units, similar to the tip 80. However, unlike other drill tips, the one shown in FIGS. 10-12 includes a generally circular profile. This is best shown in FIG. 11. As shown in FIG. 10, the drill tip 90 still includes the curved or radiused profile for the cutting edge. Again, this will provide numerous benefits, including the spreading out of forces on the cutting edge. Thus, while the drill tip 90 is of a circular profile, it will still include many, if not all, of the features of the previous drills and drill tips heretofore shown and described.

The drill tip 90 also includes a mounting structure 92 to allow it to be attached to various holders and/or drills, and can be adjusted, modified, or otherwise selected based upon the type of drill and/or holder to be used with. The drill tip 90 also includes grooves 94, 96 opposite one another on the tip 90. The grooves, which are not required in all embodiments, may be straight or spiraled.

It is to be appreciated that the exemplary embodiments shown and describe contemplate numerous variations, options, and alternatives, and not to be limited to the embodiment shown and described herein. The foregoing description has been presented for purposes of illustration and description and is not intended to be an exhaustive list or to limit the exemplary embodiments to precise forms disclosed. It is contemplated that other alternative processes obvious to those skilled in the art are considered to be included in the invention. For example, the configuration of the spade drill of the invention including the size of the various components of the spade drill may be varied and still included as part of the invention. In addition, other finishing techniques and drill preparations not disclosed may also be considered to be included as part of the invention.

Exemplary claims:

1. A drill, comprising:
a body having first and second opposite faces, and a first end and a second end, the first end including mounting apertures for mounting the drill to a holder;
first and second sides at the ends of the first and second faces and extending the height of the first end; and
a cutting edge at the second end and comprising a curved edge from one side to the other.

2. The drill of claim 1, further comprising a drilling point at a distal end of the second end along the cutting edge.

3. The drill of claim 2, further comprising first and second webs in the first and second faces at the drilling point.

4. The drill of claim 1, further comprising slots formed in the cutting edge configured to break up material of a workpiece.

5. The drill of claim 1, further comprising secondary cutting edges formed along at least a portion of the cutting edge on both the first and second faces.

6. The drill of claim 1, further comprising an edge preparation on the cutting edge on both of the first and second faces.

7. The drill of claim 6, wherein the edge preparation comprises a hone, K-land, or both.

8. The drill of claim 1, wherein the first and second faces are substantially parallel to one another.

9. The drill of claim 8, wherein the first and second sides are substantially parallel to one another.

10. The drill of claim 1, wherein the mounting apertures of the first end comprise at least one aperture through the body and a notch, wherein the mounting apertures are configured to attach the drill to the holder.

11. A drill for removing material from a workpiece, comprising:
a drill body having first and second opposing faces spaced apart of one another by the drill body thickness;
a first cutting edge at an end of the first face and being curved along the full length of the cutting edge; and
a second cutting edge at an end of the second face and being curved substantially similar and in line with the first cutting edge.

12. The drill of claim 11, further comprising a drilling point at the end of the drill body of the cutting edges and positioned substantially between the first and second faces.

13. The drill of claim 12, further comprising a first web extending generally from the drilling point to the first cutting edge, and a second web extending from the drilling point to the second cutting edge.

14. The drill of claim 11, wherein the drill body includes a mounting portion extending away from the first and second cutting edges.

15. The drill of claim 14, wherein the mounting portion comprises mounting structure to attach the drill to a holder.

16. The drill of claim 11, wherein the first and second cutting edges include slots extending at least partially from one cutting edge to the other, the slots configured to break up material of the workpiece.

17. A drill for removing material from a workpiece, comprising:
a drill body having first and second opposing faces spaced apart of one another by the drill body thickness;
a first cutting edge at an end of the first face and being curved along the full length of the cutting edge;
a second cutting edge at an end of the second face and being curved substantially similar and in line with the first cutting edge;
a first groove in the first face and first cutting edge of the drill body; and
a second groove in the second face and second cutting edge of the drill body;
wherein the first and second grooves provide for a space to allow the removed material to pass through the drill, while also providing cooling for the drill.

18. The drill of claim 17, wherein the drill body is at least partially circular.

19. The drill of claim 17, wherein the drill body further comprising a mounting portion extending away from the first and second cutting edges.

20. The drill of claim 19, wherein the mounting structure is configured to mount the drill to a replaceable drill unit.
